(19) United States
(12) Patent Application Publication
(10) Pub. No.: US 2007/0084105 A1
(43) Pub. Date: Apr. 19, 2007

(54) Portable pest control system

(75) Inventors: Bruce Lindsay, Madison, WI (US); Warren Barich, Faribault, MN (US); Daniel L. Grinols, Eagan, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Rupp Industries, Inc., Burnsville, MN (US)

(21) Appl. No.: 11/251,979

(22) Filed: Oct. 17, 2005

(51) Int. Cl. A01M 13/00; A01M 1/20; A01M 19/00

(52) U.S. Cl. 43/129; 43/132.1; 43/125

(57) ABSTRACT

The present invention relates to a mobile and self contained system for the thermal remediation of pests in an enclosed structure. The mobile system includes heating units, generators, fuel containers, vaporizers, and a control system in one pre-assembled mobile platform that enables thermal remediation of pests in a structure to be effectively carried out in a reduced amount of time and for a reduced amount of cost.

### FIELD OF THE INVENTION

The present invention relates to a method and apparatus for exterminating pests by thermal remediation of enclosed pest occupying zones. More specifically, the present invention is a method and apparatus for the application of heat using a self contained, portable and preassembled thermal remediation system.

### BACKGROUND OF THE INVENTION

Various techniques have been employed to exterminate pests, including the exposure to toxic or lethal gases. Typical fumigation techniques have included methyl bromide, dibromobenzene, phosphine, or the like as the toxic gas. These techniques involve certain risks to personnel, as well as to the environment, and hence are not readily undertaken without the necessary precautions. Furthermore, some are environmentally unfriendly. Because of the adverse affects of popular and traditional fumigants upon humans and the environment, various agencies, including environmental protection and pollution control agencies, have mandated bans upon the use of a number of traditional fumigants.

Techniques have been developed using heated air or chilled air to kill termites, pests and other organisms. Wood destroying insects, for example, termites, are killed by applying a heated gas, such as heated air, to wooden structures, objects or the like until the structure, object or the like are heated to a desired temperature, typically about 120° F. to 135° F., that is designed to kill the wood destroying insects. The structure may be held at the temperature for some desired period of time to help to insure the death of the insects or other pests. Other temperatures for killing other insects may also be achieved, but may be similar to this range. Examples of such methods are disclosed by Roger D. Johnson et al. in U.S. Pat. No. 6,141,901, Charles Forbes in U.S. Pat. No. 4,817,329, and David Hedman et al. in U.S. Pat. No. 6,327,812, which are each incorporated by reference for all that they teach and disclose.

While thermal treatment has been utilized and found to be generally acceptable, traditional thermal treatment operations have proven to be costly, burdensome, and time consuming. The equipment is typically large, heavy and difficult to move. A not insignificant portion of the cost and time associated with these thermal treatment methods includes assembling the required heating units, connecting the heating units to the structure to which the heat treatment is to be applied, and connecting the heating units to the appropriate monitoring devices for monitoring and controlling the applied heat. A forklift or crane is often needed to place the equipment, adding to the cost and time necessary to utilize the equipment.

Accordingly there is a need in the industry for a mobile and easily portable system for the application of heat to a designated structure.

### BRIEF SUMMARY OF THE INVENTION

The present invention relates generally to a self contained, preassembled and mobile system and a method for using the same for exterminating pests by thermal treatment wherein the mobile system and method include the application of heat for a period of time sufficient to eradicate or exterminate the pests or other undesirable infestation, such as insects, mold, bacteria, etc.

One embodiment of the present invention includes a mobile system for thermal remediation of a structure including a mobile platform, at least one heating unit mounted to the mobile platform, the heating unit for providing heated air, at least one fuel container mounted to the mobile platform and connected to the heating unit so as to provide fuel to the heating unit, a vaporizer connected between the fuel container and the heating unit for vaporizing the fuel as the fuel passes from the fuel container to the heating unit, and a control system operatively connected to the heating unit and the vaporizer.

Another embodiment includes a method of thermally remediating a structure to kill pests utilizing a preassembled mobile thermal remediation apparatus including the steps of placing a preassembled mobile thermal remediation apparatus in an operative position next to the structure to be thermally remediated, the preassembled mobile thermal remediation system including at least one heating unit, at least one fuel container that provides fuel to the heating unit, and a control system for controlling the heating unit, determining heating and flow parameters for the structure, connecting the preassembled mobile thermal remediation system to the structure; thermally remediating the structure, and removing the self contained mobile thermal remediation system.

Still another embodiment may be a pre-assembled mobile thermal remediation apparatus including a mobile platform, the mobile platform further including a chamber having mounted therein at least one heating unit and at least one fuel container, the fuel container operatively connected to the heating unit so as to provide a desired fuel to the heating unit, the heating unit using the fuel to heat air to a desired temperature and at a desired flow rate and a control system, the control system for controlling the temperature of the heated air and the flow rate of the heated air.

While multiple embodiments are disclosed, still other embodiments of the present invention will become apparent to those skilled in the art from the following detailed description, which shows and describes illustrative embodiments of the invention. The present invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a block diagram showing the components of the present invention mobile thermal remediation system.

FIG. 2 is a perspective view of one embodiment of the mobile platform of the present invention.

FIG. 3 is a rear plan view of the mobile platform of FIG. 2.

FIG. 4 is a perspective view of the mobile platform of FIG. 2 with one heating unit extended.

FIG. 5 is plan view of a control panel for use with the present invention.

FIG. 6 is a plan view of two vaporizers for use with the present invention.

FIG. 7 is a perspective view of a piece of fabric duct work extended into a structure.

FIG. 8 is a top shadow view of an embodiment of the present invention connected to a structure to be thermally remediated.

FIG. 9 is a flow chart showing the method of using the mobile thermal remediation system of the present invention.

### DETAILED DESCRIPTION

The present invention is a mobile thermal remediation system 10 for the thermal remediation of pests. The apparatus is self contained, preassembled and easily portable for use in the heat treatment of a desired structure 11. The remediation system 10 may be utilized to heat the structure 11 to thermally remediate any pests or insects contained therein. The present invention eliminates the necessity of building a heating system at the location to be treated and therefore reduces the time and cost associated with heat treatment.

The term “pests” generally refers to creatures such as insects, mammals, reptiles, and the like, but may also include other undesirable targets such as certain types of bacteria, microbes, molds, viruses, etc. The term “mobile” generally refers to a system that can be moved as a unit on roads, trains, ships, or other avenues of locomotion.

The structure 11 may be of a variety of sizes, shapes and locations, such as, for example, houses, warehouses, office buildings, restaurants, silos, barns, or other buildings. In addition, the present invention system may also be utilized for applying heat to mobile structures 11 such as trailers, mobile homes, boats, and the like. The structures 11 to be heated may be made of wood, steel, other metals, plastics, concrete, or stone and may include bedding, furniture, wood products, plastics, brick, tile, synthetics, foods, including frozen, processed, or fresh, fabrics, or any other material that may be a home to insects, pests, bacteria, microbes, molds or viruses.

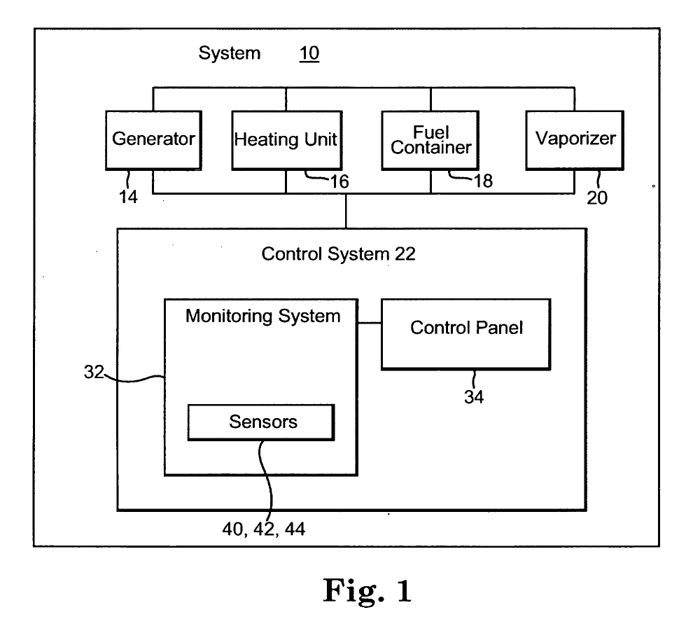

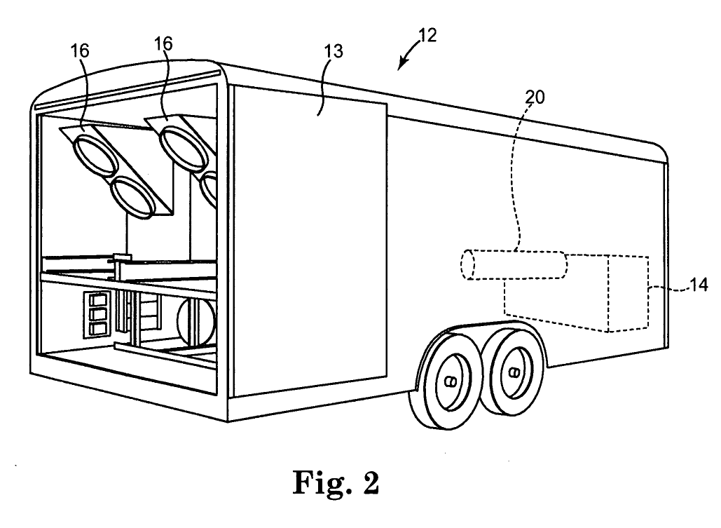

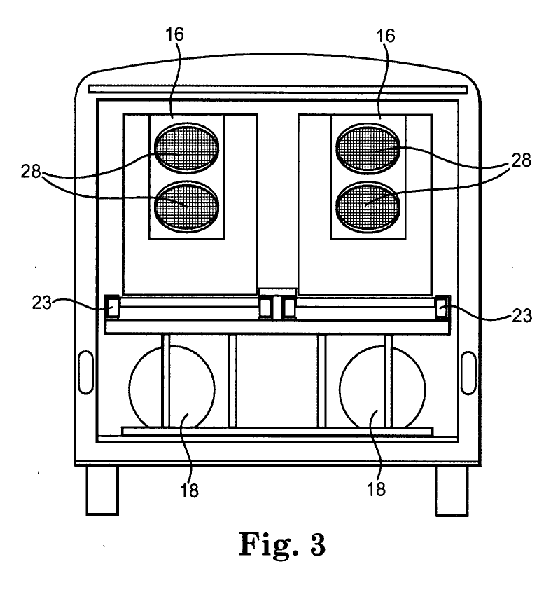

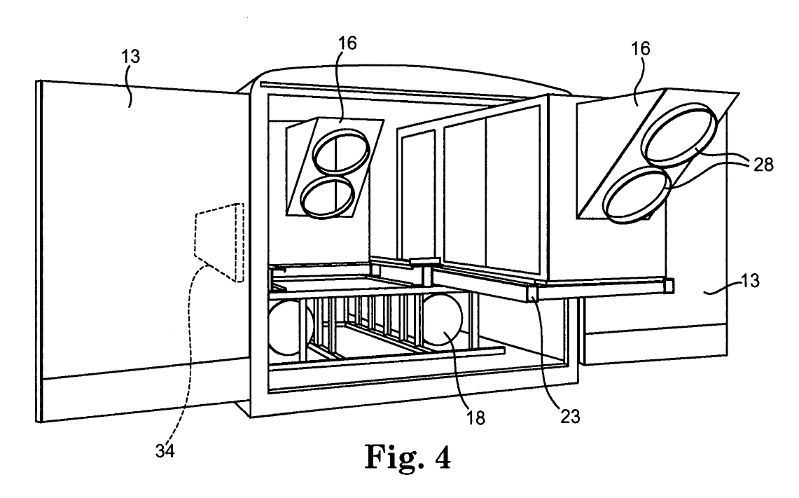

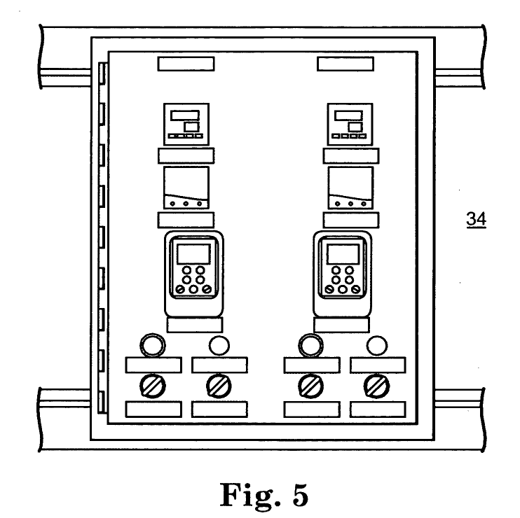

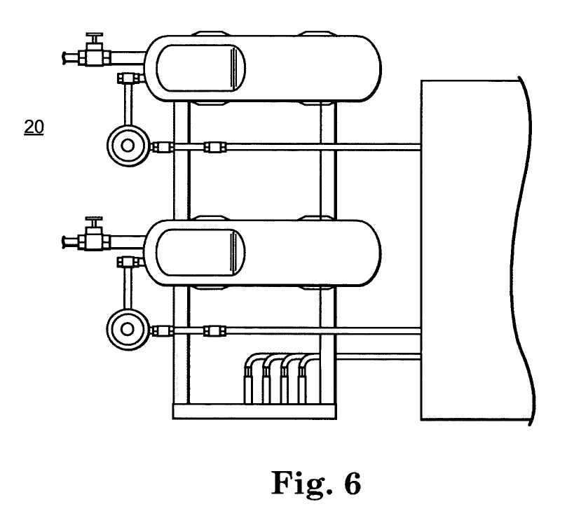

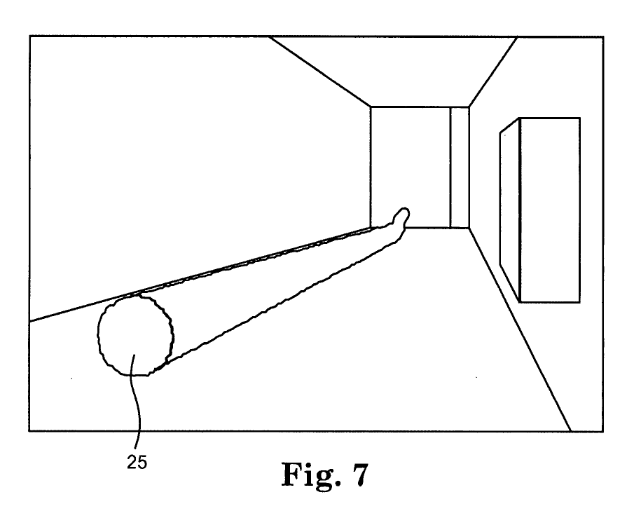

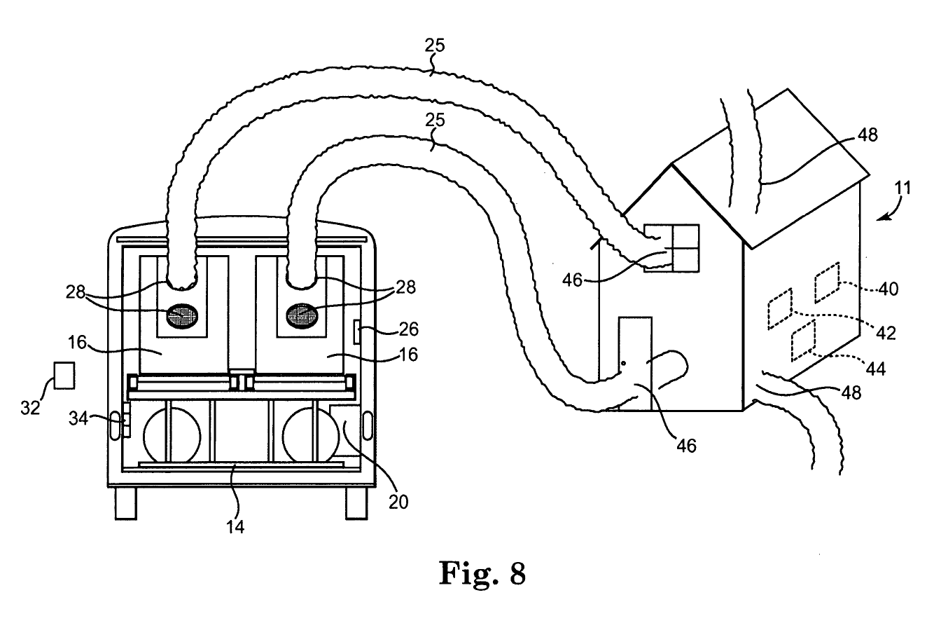

With reference to FIGS. 1-8, one embodiment of the present invention mobile thermal remediation system 10 will be herein described. The thermal remediation system may include a mobile platform 12. The mobile platform 12 may be a wheeled trailer with a double axle arrangement and may generally include an enclosed structure with walls and one or more doors 13 for accessing the equipment contained therein. The mobile platform 12 may be easily moved to a location where thermal treatment is to take place and quickly and easily positioned relative to the structure 11, eliminating extraneous lifting equipment like cranes or forklifts, for assembling a heating apparatus on site. The present embodiment mobile platform 12 may be mobile by means of towing behind a vehicle. In further embodiments the mobile platform 12 may be integrated into a truck or other vehicle.

The thermal remediation system 10 may further include one or more generators 14, heating units 16, fuel containers 18, and vaporizers 20 mounted in or on the mobile platform 12. The system 10 may further include a control system 22. The control system 22 may connect to each of the generator 14, heating units 16, fuel containers 18, vaporizers 20 and may monitor and control the operation of each.

The generator 14 provides electrical energy to the control system 22 and any other equipment that requires electrical power, such as lights, fans, monitoring equipment and sensing equipment. The generator 14 of the present embodiment is a turbo diesel system and may run on a variety of operating parameters. A fuel tank may provide diesel fuel for operation of the generator 14. In alternative embodiments other types of generators may be likewise incorporated and in still further embodiments the system 10 may be attached to an exterior power source.

The present embodiment system 10 includes two direct fired heating units 16 that provide heated air by burning propane. The heating units of the present embodiment are mounted on an interior rail system 23 so that the heating units 16 can be easily accessed through the doors 13 and extended from the mobile platform for maintenance.

The fuel containers 18 provide the propane to the heating units 16 and may be conventional liquid propane tanks. The size, shape, and construction of the fuel containers 18 may depend on the selected fuel and the regulations of the locality. In the present embodiment three 76 gallon tanks 17 are provided. In further embodiments the heating units 16 may utilize a variety of sources or fuels for heat, such as, but not limited to, butane, natural gas, electric, steam, hot water, solar, or any other power sources or combination of power sources. Appropriate fuel containers 18 or connections may be utilized depending on the heating units 16 selected. In addition, the heating units 16 may include a system for switching over to an exterior fuel source during operation in order to continue operation beyond the limitations of the fuel containers 18.

The heating units 16 may provide up to 5 million or more British thermal units (BTUs) of energy to heat the air. The amount of energy and the temperature of the air from the heating units 16 can be selectively adjusted to provide controlled temperature and air flow. The heating units 16 may further include fans (not shown), system inlet vents 26, system outlet ports 28, and flow control devices (not shown). The system inlet vents 26 provide air to the heating units 16 and to the generator 14. The inlet vents 26 may be open to the interior of the truck or may be connected to duct work contained in the mobile platform 12. The system outlet ports 28 may be arranged to channel the heated air from the heating units 16 into the structure 16.

The flow control devices and fans may be placed in the heating units themselves, in the structure 11, or in other locations, such as in duct work (further described below) 25 that carries the heated air from the mobile system 10 into the structure 11. The fans may be standard propeller fans that include on off switches or may include other features such as variable speed motors. One flow control device, may be, for example, a variable valve, such as a butterfly valve, for limiting the air flowing in or out vent 26 and port 28.

The fans, system inlet vents 26, system outlet ports 28 and flow control devices may be controlled by the control system 22 to regulate the flow of air into the heating units 16 and from the heating units 16 into the structure 11. The fans may also be any other type of air movement device, such as a blower. The operation of the heating units 16 and the placement of the fans, vent 26, port 28 and flow control devices are further described below. In further embodiments the system 10 may include exhaust ports, when using, for example, indirect fired heating units 16, to vent exhaust from the mobile system 12. In alternative embodiments one or more than two heating units 16 may be part of the system 10 and mounted in or on the mobile platform 12.

The duct work 25 may be any sort of duct work 25 capable of carrying heated air. The present embodiment duct work 25 may be 18 inch diameter flexible fabric duct work. The duct work 25 may include an open end, holes, or other slits and openings for disbursement of the air into the structure 11. In certain embodiments the duct work 25 may be supplied without openings and the operator may make openings at selected locations to direct the heated air from the duct work 25 into the structure 11. The duct work 25 may be made of fabric that is resistant to high temperatures. Fabric has the advantage of being easily adaptable to angles or turns. The fabric may further be connected to the system 10 by Velcro, zippers or other connection means and may have a low resistance to air movement and may further be easily customizable to various structures 11. In further embodiments the duct work 25 may be any kind of material known to be useful for carrying air, such as, for example, aluminum.

In various embodiments one or more than one structure inlet port 46 and structure outlet port 48 may also be utilized. Structure inlet ports 46 may connect the structure 11 to the system 10 through any suitable opening, such as a window or door, or through part of the structure's 11 HVAC system. If any portion of the window, door or HVAC system is not covered by the structure inlet port 46 than it may be sealed to prevent air leakage. In the present embodiment the duct work 25 is positioned to extend through the structure inlet port 46 and into structure 11. In additional embodiments the duct work 25 may extend to or into the structure inlet port 46 and connect with another air circulation system.

In the present embodiment the structure outlet port 48 may vent all of the air exiting the structure 11 to the atmosphere. In further embodiments the structure outlet port 48 may route some or all of the air back to the mobile system 10 to be reheated and blown back into the structure. Other areas for air flow in and out of the structure 11 may then be sealed. The outlet ports may include duct work 25 to route the air away from the structure 11 or may just be an opening or vent in the side or top of the structure.

A blower or vacuum may be connected to the structure outlet port 48 in order to remove air from the interior of the structure 11. In one embodiment, the removed air may be filtered, typically utilizing a high particulate filter, ULPA filters, or the like, coupled with the structure outlet port 48. The filter or air scrubber may remove the remains of the organisms and volatile organic compounds (VOCs) from the air to prevent them from reaching the environment. Other filters such as charcoal filters or UV filters may be employed as well. Filters may also be used to filter air entering the structure.

The vaporizers 20 may be liquid propane vaporizers. Vaporizers 20 help to vaporize the liquid propane to increase fuel efficiency and help to utilize all of the fuel from the fuel containers 18. During cold weather heat treatments the vaporizer 20 helps to turn the liquid fuel into gas before the fuel is burned in the heating unit 16. The vaporizers 20 may be any standard vaporizer equipment known to those in the art for propane or any other desired fuel.

The control system 22 of the present invention may include a monitoring system 32 and a control panel 34. The monitoring system 32 may be in the form of a computer that includes a computer program for monitoring the atmospheric factors inside the treated structure, such as temperature, humidity, air flow, and pressure. The monitoring system 32 may include temperature sensors 40, humidity sensors 42, and air flow and pressure sensors 44. The monitoring system 32 may also keep track of the heat output from the system 10, the amount of fuel in fuel container 18, and the operation of other components of system 10. In further embodiments the monitoring system 32 may monitor carbon dioxide, carbon monoxide, VOCs or other gases or atmospheric conditions.

The temperature sensors 40 may have thin, elongated tips that can be adhered to or pushed into materials to be heated or into suitably sized holes drilled into such materials so as to measure the surface and/or internal temperature. The other sensors 42 and 44 and the temperature sensor 40 may be any type of sensor device useful in the present invention. The sensors 40, 42, 44 may provide real time readings to the control system 22 to display and record the temperature at each sensor in real time. Alternatively, the sensors may be wireless and transmit a signal to the console. Typical sensors may include, for example, thermal couples, thermistors, or the like. Additional sensors that measure other parameters may also be included, such as, for example a pressure measuring device.

The control panel 34 may be integrated with the monitoring system 32 or operate separately. If separate, the monitoring system 32 may be observed by the operator who then separately enters commands into the control panel 34. In additional embodiments, the monitoring system 32 and control panel 34 may be integrated into one unit, such as a computer.

The control panel 34 may control the generator 14, heating units 16, and the vaporizer 20, in addition to other portions of the system 10, such as fans. As may be appreciated, a variety of different types of monitoring systems 32 and control panels 34 may be utilized that provide a number of different features, including computer displays and inputs, digital displays and inputs, or plain dials and switches to display and control the portions of system 10

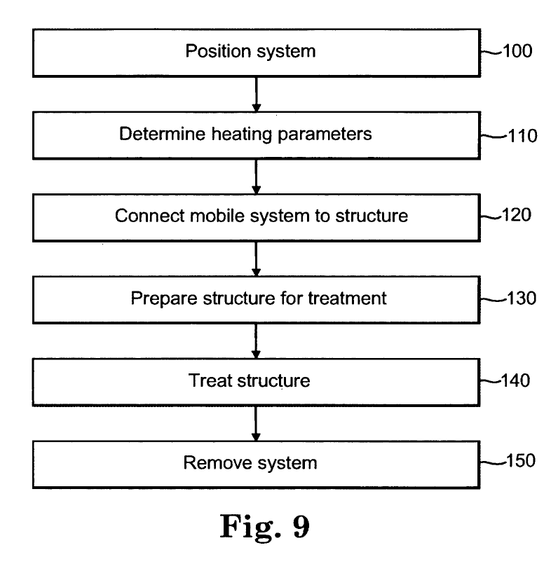

With reference to FIG. 9, operation of one embodiment of the mobile system 10 will be herein described. The system 10 is first positioned in an operative position near the structure 11 to be treated (100). The system 10 is self contained, pre-assembled and portable so bringing the components to the structure 11 to be treated involves towing or driving the mobile platform 12 near to the structure 11 and parking it. The operative position may be as close or as far from the structure as is desired and manageable in view of the structure 11 itself, the surrounding landscape, and the amount of duct work 25 that is going to be utilized. The present invention requires minimal to no assembly of the equipment at the site of the structure 11. Duct work 25 and other equipment may be brought in the mobile platform 12. Additional duct work 25, fans, and other flow control devices may also be brought to the structure 11 separately. If additional fuel is required, that may also be separately delivered but may not be necessary.

The heating and flow parameters of the structure 11 are then determined (110). Selection of the number of air changes, temperature ramping, etc. can be completed by those of skill in the art using known techniques to form a remediation plan. The time and temperature parameters of the plan may be selected based upon the pests to be exterminated and the structure 11 being treated. The dimensions, type of structure 11, as well as the area of structure to be treated is analyzed and considered. The heat movement, air distribution, placement of the equipment, and locations for heated air discharge may also be considered. This step may generally be characterized as the determination of air penetration parameters for the treatment zone. Building data may also be analyzed and used to help determine the heating and flow parameters. Building data that is taken into account may include the building materials, height, whether a basement is being heated, and more. With this building data, specific heat loss calculations may be made in order to more specifically determine the heat treatment parameters. Placement of equipment may then be determined based on this information.

The heating parameters should include heating the air, the materials forming structure 11, and the materials contained in the structure 11, to at least a lethal temperature. The term “lethal temperature” is intended to refer to a temperature which is sufficient to kill a variety of pests. A temperature of about 120° F.-130° F. is generally an adequate lethal temperature, however, some pests may require a slightly higher temperature to be effective. For a more complete disinfection, the temperature may be raised to at least about 120° F., 130° F., 140° F., or 150° F. or higher. In additional embodiments the temperature may be heated to temperatures in the range of about 110° F. to 750° F., or higher. The lethal temperature may also be effective for the destruction of any eggs, larvae, or pupae that may be present. In further embodiments, a biocide may be selected for introduction with the heated air. Such biocide's characteristics may or may not be enhanced by utilization with the heated air.

In addition, a ramp-up temperature rate may be selected based upon several factors, including materials present in the structure and time allotted for treatment. The lethal temperature and the ramp-up temperature rates may be selected to avoid structural damage caused by thermal stresses within the treatment zone. The ramp-up rate should also be selected such as to be sufficient to trap pests, particularly mammals or reptiles, before they are able to escape the zone. A total thermal remediation time may also be set.

The system 10 is then connected to the structure (120). The main portions of the system 10 are already assembled and connected inside of the mobile platform 12, eliminating the use of cranes or forklifts and reducing the requirement of skilled labor. In addition, the heating units 16, fuel containers 18, vaporizers 20 and the hoses and connections between each are self contained in the mobile platform 12, thereby eliminating exposed lines containing combustible fuels. Moreover, the heating units 16 and other equipment do not have to be placed in or on the structure 11 to be remediated.

The system outlet ports 28 may be connected by the duct work to the structure 11 through the structure inlet port 46. The duct work 25 may be flexible or hard and should be resistive to any chemicals (biocides) that may be incorporated for use during heat treatment. In different embodiments one, two, or more system outlet ports 28 may be utilized to connect the system 10 to the structure 11. Additional blowers or fans are positioned within the structure 11 to circulate the air and aid in heat distribution. The sensors 40, 42, and 44 may be positioned at predetermined locations to monitor the temperature of the structure 11 and to provide information to the monitoring system 32. Other fans and flow control devices may also be placed in predetermined locations to determine whether the required temperature levels are achieved.

The structure may next be prepared for heat treatment (130). Preparing the structure may involve removing all heat-sensitive items from the enclosure or, in some cases, covering heat sensitive items, such as electronic devices and plastic items, with thermal insulation material. In further cases, preparing the structure may also involve physically removing visible pests.

The structure 11 is then heat treated (140). The heated air (and biocide, if desired) from the one or more heating units 16 may be directed throughout the structure 11. Generally, a plurality of system outlet ports 28 and structure inlet ports 46 will be used to achieve the optimum distribution of hot air throughout the enclosed structure 11. The system inlet vents 26, the system outlet ports 28, structure inlet ports 46, structure outlet ports 48 and duct work 25 may also include flow control devices, like flow dampers, which may be moved, adjusted, or turned on and off while the system is in operation to achieve the desired air flow into the structure 11.

The mobile thermal remediation system 10 may be used to apply heated outside air or air rerouted from the structure 11, or a blended combination of both, to the structure 11. The utilization of outside air may be effective in holding the relative humidity of the area in the structure to be treated down to a point to deny the pests this added measure of protection. Heated outside air is also advantageous in that water vapor present within the treatment zone is being continuously driven from the zone, without being retained and/or accumulated as would be the case in a system employing recirculation.

The technician running the heat treatment may monitor selected heating parameters during the heat treatment of the structure 11 from a single point. Monitoring of the air flow through the structure 11, for example, is useful in order to be certain interior hard-to-reach zones, such as intra-wall spacings and the like, are effectively treated. During the heat treatment time, information from the sensors 40, 42, and 44 are monitored in real time to insure that the areas within structure 11 are properly treated. The data may also be logged by a computer or other data logging system.

Control of the fans and other flow control devices may assure the desired temperature is reached throughout the treated structure. At any time during system operation, the amount of heated air provided by the heating units 16 may be adjusted in response to readings from the monitoring system 32. Adjustments may be made by the technician during operation to reach the desired temperature at the desired rate and to maintain the desired temperature. Adjustments may be made using the control panel, adjusting the speed of fans (or turning them on or off), or by physically moving the duct work 25 inside of the structure 11. In still further embodiments the temperature and air flow may be controlled by a computer. In one alternative embodiment the structure 11 may be kept under a positive air pressure so as to achieve maximum heat penetration.

The heat treatment process may be run for a period of minutes, hours, days or even weeks to ensure that the structure 11 is properly treated. Different structures 11 to be treated may require more or less heating capacity. Additional fuel may be added to the mobile platform 12 during operation by, for example, refilling the fuel containers 18. The system 10 may also be hooked up to additional outside fuel sources, if necessary.

After a predetermined period of time in which it has been determined that the pests and other targets have been destroyed, the introduction of heated air to the structure is stopped. The system 10 is then removed (150). Removal of the system 10 may be accomplished quickly as compared to prior thermal remediation systems. The duct work, fans, and sensors 40, 42, 44 can be removed at the same pace as with any other heat treatment system or method. The mobile platform 12, being a complete unit for providing heated air, requires minimal or no deconstruction. The heating units 16 may be simply pushed back into the mobile platform 12, the doors 13 closed, and the mobile platform 12 hauled away. Removal of the mobile platform 12 saves worker time and therefore reduces the cost of the overall heat treatment.

In one alternative embodiment a negative pressure can be created inside the structure 11 to be treated. The negative pressure may result from fans pushing air out of the structure.

In another embodiment the mobile platform 12 may be of a variety of shapes and sizes and may include greater or fewer axles. The mobile platform 12 may be integrated with a van, truck, other vehicle, or transportable unit, such as a modular shipping container. In still further embodiments the mobile platform 12 may be integrated into a boat or other floating structure.

In further embodiments, depending on the size of the structure 11 to be treated, more than one mobile system 10 may be connected to the structure 111 at a variety of positions. In still further embodiments, only a portion of the structure 111 may be heat treated. This may be accomplished by sealing off parts of the structure 111 using plastic, doors, or temporary walls.

In order to provide a further means of determining that a sufficient lethal or elevated temperature is reached, and that the lethal temperature has been achieved for a sufficient period of time, test cages may be set in place throughout the treatment zone. Monitoring of these test cages may help to indicate the total effectiveness of the kill.

Various modifications and additions can be made to the exemplary embodiments discussed without departing from the scope of the present invention. Accordingly, the scope of the present invention is intended to embrace all such alternatives, modifications, and variations as fall within the scope of the claims, together with all equivalents thereof.

1. A mobile system for thermal remediation of a structure, the system comprising:
a mobile platform;
at least one heating unit for providing heated air mounted on the mobile platform, the mobile platform adapted to transport the heating unit to a desired location and to position the heating unit relative to a separate structure to be heated;
at least one fuel container mounted to the mobile platform and connected to the heating unit so as to provide fuel to the heating unit;
a vaporizer connected between the fuel container and the heating unit for vaporizing the fuel as the fuel passes from the fuel container to the heating unit;
a control system operatively connected to the heating unit and the vaporizer;
an outlet port connected to the mobile platform, the outlet port arranged to channel the heated air from the heating unit mounted on the mobile platform to the separate structure to be heated; and
a duct work system connected to the outlet port and to the structure to be heated, the duct work system carrying the heated air from the heating unit mounted on the mobile platform and into the separate structure to be remediated.

2. The mobile system of claim 1 further comprising a generator for supplying power to the mobile system.

3. The mobile system of claim 1 wherein the mobile platform is a wheeled trailer, the wheeled trailer of such a size and shape to be towed behind a truck.

4. The mobile system of claim 1 wherein the at least one heating unit is a propane burner.

5. The mobile system of claim 1 wherein the at least one fuel container is a liquid propane tank.

6. The mobile system of claim 1 wherein the control system further comprises a monitoring system, the monitoring system including one or more sensors for collecting data from inside the structure.

7. The mobile system of claim 6 wherein the monitoring system includes a temperature sensor.

8. The mobile system of claim 1 wherein the air to be heated is drawn from outside of the structure.

9. The mobile system of claim 1 wherein the at least one heating unit includes a blower for moving the heated air from the heating unit.

10. The mobile system of claim 1 wherein the at least one heating unit is slidably mounted to the platform.

11. A method of thermally remediating a structure to kill pests utilizing a preassembled mobile thermal remediation apparatus comprising:
placing a preassembled mobile thermal remediation apparatus in an operative position next to the structure to be thermally remediated, the preassembled mobile thermal remediation system including at least one heating unit, at least one fuel container that provides fuel to the heating unit, and a control system for controlling the heating unit;
determining heating and flow parameters for the structure;
connecting the preassembled mobile thermal remediation system to the structure;
thermally remediating the structure; and
removing the self contained mobile thermal remediation system.

12. The method of claim 111 further comprising monitoring the structure to determine that the desired temperature has been achieved.

13. The method of claim 11 wherein connecting the self contained mobile thermal remediation system to the structure further comprises attaching fabric duct work to a system outlet port and to a structure inlet port whereby the fabric duct work channels the air heated by the at least one heating unit into the structure.

14. The method of claim 11 wherein determining heating and flow parameters further comprises selecting a temperature ramp rate.

15. The method of claim 11 wherein determining heating and flow parameters further comprises selecting a desired total time to thermally remediate.

16. The method of claim 111 further comprising monitoring and controlling the heating and flow parameters from a single location.

17. A pre-assembled mobile thermal remediation apparatus comprising:
a mobile platform, the mobile platform further including a chamber having mounted therein at least one heating unit and at least one fuel container, the fuel container operatively connected to the heating unit so as to provide a desired fuel to the heating unit, the heating unit using the fuel to heat air to a desired temperature and at a desired flow rate, and the mobile platform for transporting the heating unit and the fuel container to a desired location and position relative to a separate structure to be heated;
a control system, the control system for controlling the temperature of the heated air and the flow rate of the heated air;
an outlet port connected to the mobile platform, the outlet port arranged to channel the heated air from the heating unit mounted on the mobile platform to the separate structure to be heated; and
a duct work system connected to the outlet port and to the structure to be heated, the duct work system carrying the heated air from the heating unit mounted on the mobile platform and into the structure to be remediated.

18. The mobile thermal remediation apparatus of claim 17 further comprising a monitoring system for monitoring one or more air parameters inside of the structure.

19. The mobile thermal remediation apparatus of claim 17 wherein the mobile platform is a trailer.

20. The mobile thermal remediation apparatus of claim 17 wherein the desired fuel is propane.

21. The mobile thermal remediation apparatus of claim 17 further comprising at least one vaporizer.
